(19) United States
(12) Patent Application Publication
(10) Pub. No.: US 2026/0197060 A1
(43) Pub. Date: Jul. 9, 2026

(54) CHANNEL STATE INFORMATION DETERMINING METHOD, TERMINAL, AND NETWORK SIDE DEVICE

(71) Applicant: VIVO MOBILE COMMUNICATION CO., LTD., Dongguan (CN)

(72) Inventors: Hao LIU, Dongguan (CN); Jiangwei YUAN, Dongguan (CN)

(21) Appl. No.: 19/553,221

(22) Filed: Feb. 28, 2026

Related U.S. Application Data
(63) Continuation of application No. PCT/CN2024/114561, filed on Aug. 26, 2024.

(30) Foreign Application Priority Data
Sep. 1, 2023 (CN) 202311128017.0

(51) Int. Cl. H04B 7/06; H04L 5/00

(52) U.S. Cl. CPC H04B 7/0626; H04L 5/0048

(57) ABSTRACT

This application discloses a channel state information determining method, a terminal, and a network side device, and pertains to the field of communication technologies. The channel state information determining method in embodiments of this application includes: determining, by a terminal, CSI corresponding to N second ports based on channel state information reference signals CSI-RSs corresponding to M first ports; and sending the CSI corresponding to the N second ports to a network side device; where the N second ports are CSI-RS ports configured by the network side device for the terminal, and the M first ports are some ports in the N second ports.

This application is a continuation of International Patent Application No. PCT/CN2024/114561, filed on Aug. 26, 2024, which claims priority to Chinese patent application No. 202311128017.0, filed with the China National Intellectual Property Administration on Sep. 1, 2023 and entitled “CHANNEL STATE INFORMATION DETERMINING METHOD, TERMINAL, AND NETWORK SIDE DEVICE”, both of which are incorporated herein by reference in their entirety.

### TECHNICAL FIELD

This application pertains to the field of communication technologies, and in particular, to a channel state information determining method, a terminal, and a network side device.

### BACKGROUND

In a related technology, to ensure that a future commercially available centimeter-wave frequency band from 7 GHz to 15 GHz can achieve network coverage comparable to that of a low-frequency frequency band of 3.5 GHZ, an extremely large aperture array that matches a new frequency band is introduced on the basis of an already commercialized large-scale antenna design.

Main features of an extremely large aperture array (Extremely Large Aperture Array, ELAA) are that there are a massive quantity of antenna elements and more radio frequency links may be introduced to improve a spatial-domain sampling rate of a wireless channel. Therefore, in a future channel state information reference signal (Channel State Information reference signal, CSI-RS) port design, support for a larger quantity of ports needs to be taken into consideration. For example, at present, a maximum quantity of CSI-RS ports (port) used in a 5G new radio (New Radio, NR) protocol to measure a downlink channel is 32, and in the future, the maximum quantity of ports may need to be extended to 48, 64, 96, or even 128.

### SUMMARY

Embodiments of this application provide a channel state information determining method, a terminal, and a network side device.

According to a first aspect, a channel state information determining method is provided, including: determining, by a terminal, CSI corresponding to N second ports based on channel state information reference signals CSI-RSs corresponding to M first ports, where M and N each are an integer greater than 1; and sending the CSI corresponding to the N second ports to a network side device; where the N second ports are CSI-RS ports configured by the network side device for the terminal, and the M first ports are some ports in the N second ports.

According to a second aspect, a channel state information determining method is provided. A network side device receives channel state information CSI corresponding to N second ports that is sent by a terminal, where the CSI corresponding to the N second ports is determined based on channel state information reference signals CSI-RSs corresponding to M first ports, the N second ports are CSI-RS ports configured by the network side device for the terminal, and the M first ports are some ports in the N second ports, where M and N each are an integer greater than 1.

According to a third aspect, a channel state information determining apparatus is provided, including: a determining module and a sending module. The determining module is configured to determine CSI corresponding to N second ports based on channel state information reference signals CSI-RSs corresponding to M first ports, where M and N each are an integer greater than 1. The sending module is configured to send the CSI corresponding to the N second ports to a network side device. The N second ports are CSI-RS ports configured by the network side device for the terminal, and the M first ports are some ports in the N second ports.

According to a fourth aspect, a channel state information determining apparatus is provided, including: a receiving module, configured to receive channel state information CSI corresponding to N second ports that is sent by a terminal.

The CSI corresponding to the N second ports is determined based on channel state information reference signals CSI-RSs corresponding to M first ports, the N second ports are CSI-RS ports configured by the network side device for the terminal, and the M first ports are some ports in the N second ports, where M and N each are an integer greater than 1.

According to a fifth aspect, a terminal is provided. The terminal includes a processor and a memory, the memory stores a program or instructions capable of running on the processor, and when the program or the instructions are executed by the processor, the steps of the method according to the first aspect are implemented.

According to a sixth aspect, a chip is provided. The chip includes a processor and a communication interface, the communication interface is coupled to the processor, and the processor is configured to run a program or instructions to implement the steps of the method according to the first aspect.

According to a seventh aspect, a network side device is provided. The network side device includes a processor and a memory, and the memory stores a program or instructions capable of running on the processor. When the program or the instructions are executed by the processor, the steps of the method according to the second aspect are implemented.

According to an eighth aspect, a network side device is provided. The network side device includes a processor and a communication interface, the communication interface is coupled to the processor, and the processor is configured to run a program or instructions to implement the steps of the method according to the second aspect.

According to a ninth aspect, a readable storage medium is provided. The readable storage medium stores a program or instructions, and when the program or the instructions are executed by a processor, the steps of the method according to the first aspect are implemented, or the steps of the method according to the second aspect are implemented.

According to a tenth aspect, a wireless communication system is provided, including a terminal and a network side device. The terminal may be configured to perform the steps of the method according to the first aspect, and the network side device may be configured to perform the steps of the method according to the second aspect.

According to an eleventh aspect, a chip is provided. The chip includes a processor and a communication interface. The communication interface is coupled to the processor, and the processor is configured to run a program or instructions, to implement the steps of the method according to the first aspect or the steps of the method according to the second aspect.

According to a twelfth aspect, a computer program product/program product is provided. The computer program product/program product is stored in a storage medium, and the program/program product is executed by at least one processor to implement the steps of the method according to the first aspect or the steps of the method according to the second aspect.

### BRIEF DESCRIPTION OF DRAWINGS

FIG. 1 is a schematic structural diagram of a wireless communication system according to an example embodiment of this application;

FIG. 2 is a first schematic flowchart of a channel state information determining method according to an example embodiment of this application;

FIG. 3 is a second schematic flowchart of a channel state information determining method according to an example embodiment of this application;

FIG. 4 is a third schematic flowchart of a channel state information determining method according to an example embodiment of this application;

FIG. 5A is a first schematic diagram of an antenna panel according to an example embodiment of this application;

FIG. 5B is a second schematic diagram of an antenna panel according to an example embodiment of this application;

FIG. 5C is a third schematic diagram of an antenna panel according to an example embodiment of this application;

FIG. 6 is a fourth schematic flowchart of a channel state information determining method according to an example embodiment of this application;

FIG. 7 is a first schematic structural diagram of a channel state information determining apparatus according to an example embodiment of this application;

FIG. 8 is a second schematic structural diagram of a channel state information determining apparatus according to an example embodiment of this application;

FIG. 9 is a schematic structural diagram of a communication device according to an example embodiment of this application;

FIG. 10 is a schematic structural diagram of a terminal according to an example embodiment of this application; and

FIG. 11 is a schematic structural diagram of a network side device according to an example embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, “or” in this application represents at least one of connected objects. For example, “A or B” covers three solutions, that is, solution 1: including A and not including B; solution 2: including B and not including A; and solution 3: including A and B. The character “/” generally indicates an “or” relationship between associated objects.

The term “indication” in this application may be either a direct indication (or an explicit indication) or an indirect indication (or an implicit indication). A direct indication may be understood as: A transmitter explicitly notifies, in a transmitted indication, a receiver of content such as specific information, an operation that needs to be performed, or a request content. An indirect indication may be understood as: A receiver determines corresponding information based on an indication sent by a transmitter, or performs determining and determines, based on a determining result, an operation that needs to be performed, a request result, or the like.

It should be noted that technologies described in the embodiments of this application are not limited to a Long Term Evolution (Long Term Evolution, LTE)/LTE-Advanced (LTE-Advanced, LTE-A) system, and may further be applied to other wireless communication systems such as Code Division Multiple Access (Code Division Multiple Access, CDMA), Time Division Multiple Access (Time Division Multiple Access, TDMA), Frequency Division Multiple Access (Frequency Division Multiple Access, FDMA), Orthogonal Frequency Division Multiple Access (Orthogonal Frequency Division Multiple Access, OFDMA), single-carrier frequency division multiple access (Single-carrier Frequency Division Multiple Access, SC-FDMA), or other systems. The terms “system” and “network” in the embodiments of this application may be used interchangeably. The technologies described can be applied to both the systems and the radio technologies mentioned above as well as to other systems and radio technologies. An NR system is described below for example purposes, and NR terms are used in most of the following descriptions, but these technologies can also be applied to a system other than an NR system, for example, a 6^{th} generation (6th Generation, 6G) communication system.

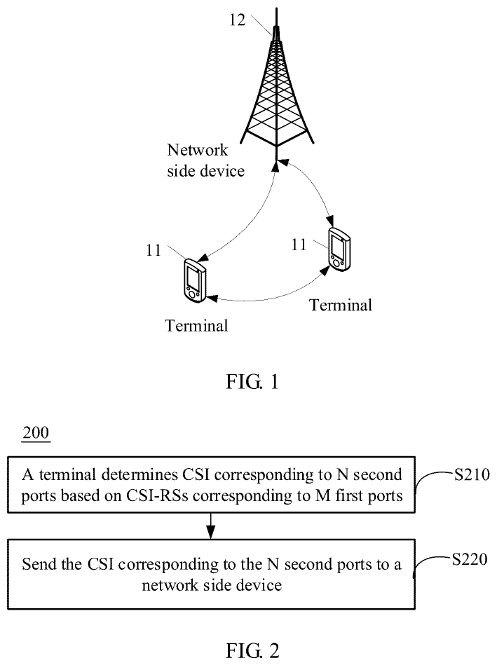

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile Internet device (Mobile Internet Device, MID), an augmented reality (Augmented Reality, AR) device, a virtual reality (Virtual Reality, VR) device, a robot, a wearable device (Wearable Device), a flight vehicle (flight vehicle), vehicle user equipment (Vehicle User Equipment, VUE), ship-borne equipment, pedestrian user equipment (Pedestrian User Equipment, PUE), a smart home device (a home device with a wireless communication function, such as a refrigerator, a television, a washing machine, or furniture), a game console, a personal computer (Personal Computer, PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a radio access network (Radio Access Network, RAN) device, a radio access network function, or a radio access network unit. The access network device may include a base station, a wireless local area network (Wireless Local Area Network, WLAN) access point (Access Point, AS), a wireless fidelity (Wireless Fidelity, WiFi) node, and the like. The base station may be referred to as a NodeB (Node B, NB), an evolved NodeB (Evolved Node B, eNB), a next-generation node B (the next generation Node B, gNB), a new radio NodeB (New Radio Node B, NR Node B), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home Node B, HNB), a home evolved NodeB (home evolved Node B), a transmission reception point (Transmission Reception Point, TRP), or another suitable term in the field, provided that a same technical effect is achieved, and the base station is not limited to a specific technical vocabulary. It should be noted that only a base station in an NR system is used as an example in this embodiment of this application for description, and a specific type of the base station is not limited.

In addition, for ease of understanding of the technical solutions provided in this application, several technical features involved in this application are briefly described herein.

### (1) CSI-RS Pattern (Pattern)

A design pattern of the CSI-RS pattern is defined in the 38.211 protocol. Currently, a quantity of ports supported by a CSI-RS is {1, 2, 4, 8, 12, 16, 24, 32}. For a same quantity of ports, there are different pattern designs that match different channel types. For a CSI-RS resource (resource), orthogonality needs to be ensured between different ports. Orthogonality is generally ensured through time division, frequency division, or frequency domain spread spectrum or even combined time-frequency two-dimensional spread spectrum. A single-port CSI-RS is generally used for channel feature tracing, and is also referred to as a tracking RS (Tracking RS, TRS) in this case. A terminal may estimate a timing offset, a frequency offset, a multi-path spectrum and a Doppler spectrum of a wireless channel based on a plurality of TRS resources. Obtaining of these spectrum information can assist in improving DMRS channel estimation performance used for demodulation.

### (2) Quasi Co-Location (Quasi Co-Location, QCL)-Type (Type)

QCL means that a channel large-scale parameter experienced by a symbol on a specific antenna port may be inferred from a channel experienced by a symbol on another antenna port (or understood as being the same in parameter characteristic). The large-scale parameter includes an average delay (average delay), a delay spread (delay spread), a Doppler shift (Doppler shift), a Doppler spread (Doppler spread), a spatial reception parameter (Spatial Rx parameter), and the like.

Currently, four QCL types are defined in the 5G NR protocol:
QCL Type A: a Doppler shift, a Doppler spread, an average delay, and a delay spread;
QCL Type B: a Doppler shift and a Doppler spread;
QCL Type C: an average delay and a Doppler shift;
QCL Type D: a spatial reception parameter.

The QCL type A, the QCL type B, and the QCL type C may be used for all frequency bands, and the QCL type D is only used for a millimeter-wave high frequency band.

In related art, measuring full-channel CSI by using a large quantity of CSI-RS ports inevitably incurs high CSI-RS resource overheads and affects network performance.

Embodiments of this application provide a channel state information determining method, a terminal, and a network side device, to reduce CSI-RS resource overheads during determining of full-channel CSI and ensure network performance.

Based on this, with reference to the accompanying drawings, the technical solutions provided in the embodiments of this application are described in detail below by using some embodiments and application scenarios thereof.

As shown in FIG. 2, FIG. 2 is a schematic flowchart of a channel state information determining method 200 according to an example embodiment of this application. The method 200 may be performed by a terminal, without limitation, and may be specifically performed by hardware or software installed in the terminal. In this embodiment, the method 200 may include at least the following steps.

S210: The terminal determines CSI corresponding to N second ports based on CSI-RSs corresponding to M first ports. M and N each are an integer greater than 1.

The N second ports are CSI-RS ports configured by a network side device for the terminal (which may also be understood as ports associated with a CSI report), and the M first ports are some ports in the N second ports. In other words, in this embodiment, the first port may be considered as an actually received CSI-RS port (or a CSI-RS pilot port), and the second port may be considered as a CSI-RS port defined or configured for the CSI report. In this case, the terminal determines (or derives and estimates) CSI of N CSI-RS ports by using CSI-RSs corresponding to some ports in the N CSI-RS ports. Therefore, a problem that CSI-RS resource overheads are high when channel measurement needs to be performed on each of the N CSI-RS ports in a related technology to obtain full-channel CSI can be avoided, thereby effectively ensuring network performance.

For example, if it is assumed that the network side device configures N (for example, 32, 64, or 128) CSI-RS ports, compared with a case in the related technology that the network side device needs to send CSI-RSs on the N CSI-RS ports and the terminal needs to receive and measure the CSI-RSs based on the N CSI-RS ports to obtain CSI corresponding to each CSI-RS port based on a measurement result, in this embodiment, the network side device only needs to send CSI-RSs on only M (for example, 32 or 16) CSI-RS ports (the foregoing first port), and the terminal needs to receive and measure the CSI-RSs based on M CSI-RS ports to determine channel estimation information (or a channel estimation result) corresponding to the M CSI-RS ports based on a measurement result, and finally, determine CSI corresponding to the N CSI-RS ports (the foregoing second port) based on the channel estimation information corresponding to the M CSI-RS ports and the like. Therefore, CSI-RS resource overheads on (N-M) CSI-RS ports required in the related technology can be avoided, thereby ensuring network performance.

Certainly, as for that the terminal determines the CSI corresponding to the N second ports based on the CSI-RSs corresponding to the M first ports, a mapping relationship (for example, a quantity or a location) between the M first ports and the N second ports may be implemented in a manner such as protocol agreement or network side device configuration. This is not limited herein.

S220: Send the CSI corresponding to the N second ports to a network side device.

The terminal may implement CSI report configuration (CSI-ReportConfig) in a manner such as protocol agreement or higher layer configuration to send the CSI corresponding to the N second ports. In addition, the terminal sends the CSI corresponding to the N second ports, so that the network side device determines a precoding matrix based on the CSI corresponding to the N second ports, and the like. This is not limited herein.

In this embodiment, the terminal determines the CSI corresponding to the N second ports based on the CSI-RSs corresponding to the M first ports, where the N second ports are CSI-RS ports configured by the network side device for the terminal, and the M first ports are some ports in the N second ports. Therefore, in a manner of determining CSI of all CSI-RS ports by using CSI-RSs corresponding to some CSI-RS ports, CSI-RS resource overheads during determining of full-channel CSI can be reduced, and network performance is effectively ensured.

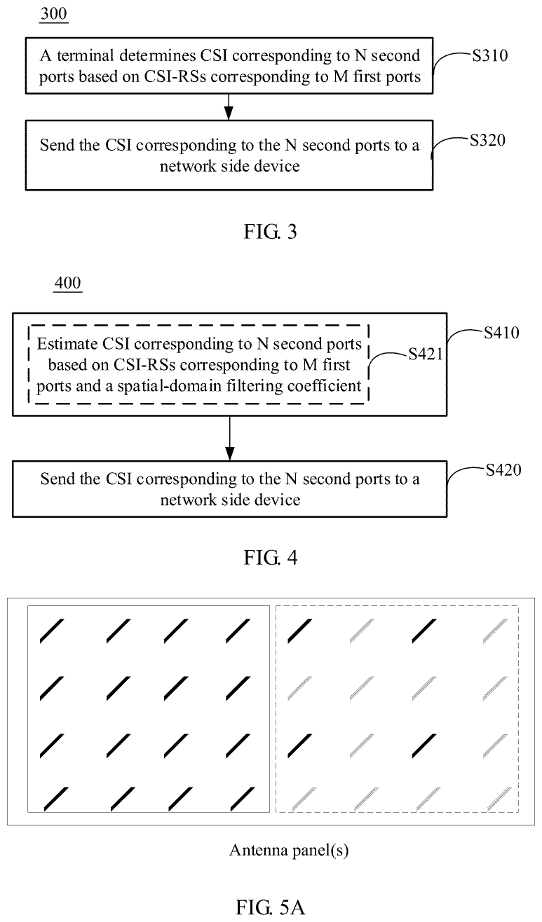

As shown in FIG. 3, FIG. 3 is a schematic flowchart of a channel state information determining method 300 according to an example embodiment of this application. The method 300 may be performed by a terminal, without limitation, and may be specifically performed by hardware or software installed in the terminal. In this embodiment, the method 300 may include at least the following steps.

S310: The terminal determines CSI corresponding to N second ports based on channel state information reference signals CSI-RSs corresponding to M first ports.

S320: Send the CSI corresponding to the N second ports to a network side device.

The N second ports are CSI-RS ports configured by the network side device for the terminal, and the M first ports are some ports in the N second ports.

It may be understood that, for an implementation process of S310 and S320, reference may be made to related descriptions in the foregoing method embodiment 200. Certainly, in addition to the related descriptions in the foregoing method embodiment 200, in a possible implementation, the first port may be mapped in a same polarization direction to M1 ports in a horizontal dimension and M2 ports in a vertical dimension, and the second port may also be mapped in a same polarization direction to N1 ports in the horizontal dimension and N2 ports in the vertical dimension. M1 is less than or equal to N1, or M2 is less than or equal to N2, M1, M2, N1, and N2 each are an integer greater than 0, M=M1*M2*q, and N=N1*N2*q, where q is related to an antenna polarization type, for example, for a dual-polarized antenna panel (Antenna panel), M=M1*M2*2, and N=N1*N2*2.

In this case, in an implementation, to implement a CSI determining solution corresponding to the N second ports in a case that CSI-RS resource overheads are reduced, in this embodiment, the terminal may receive first indication information sent by the network side device, and the first indication information is used to indicate port information that is distributed in a discrete manner on the antenna panel, so that the terminal may determine CSI on the N second ports based on a quantity of first ports, a quantity of second ports, and a mapping relationship between the first port and the second port that are indicated by the first indication information.

Optionally, the first indication information may be transmitted by using higher layer signaling, and may include or indicate but is not limited to at least one of the following: a pattern of a CSI-RS resource, and a first mapping relationship.

The pattern of the CSI-RS resource may be but is not limited to a pattern of a CSI-RS resource associated in a CSI report configuration (CSI-ReportConfig). The pattern of CSI-RS resource may include but is not limited to a quantity (for example, M1) of first ports in the horizontal dimension, a quantity (for example, M2) of first ports in the vertical dimension, a quantity (for example, N1) of second ports in the horizontal dimension, and a quantity (for example, N2) of second ports in the vertical dimension.

In some embodiments, a quantity of first ports (for example, M1 and M2) and a quantity of second ports (for example, N1 and N2) that are used when the terminal determines CSI may be determined based on a quantity of first ports and a quantity of second ports that are configured in the pattern of the CSI-RS resource. This is not limited herein.

A mapping relationship between the N1 second ports and the M1 first ports or a mapping relationship between the N2 second ports and the M2 first ports is configured in the first mapping relationship. The “mapping relationship between the N1 second ports and the M1 first ports” may be understood as a selection mapping relationship for selecting the M1 first ports from the N1 second ports, for example, from locations of the M1 first ports in the N1 second ports. Correspondingly, the “mapping relationship between the N2 second ports and the M2 first ports” may also be understood as a selection mapping relationship for selecting M2 second ports from the N2 second ports, for example, from locations of the M2 first ports in the N2 second ports.

It may be understood that, by using the foregoing indication of the quantity of ports in the pattern of the CSI-RS resource and the first mapping relationship, the terminal can know a quantity and locations of ports used by the network side device to send the CSI-RS, to implement accurate receiving and measurement of the CSI-RS (for example, the CSI-RS), and in addition, the terminal can accurately determine the CSI corresponding to the N second ports based on the CSI-RSs corresponding to the M first ports.

Certainly, for the foregoing first indication information, if only one of the pattern of the CSI-RS resource or the first mapping relationship is indicated in the first indication information, the remaining information may be configured for the terminal in a manner such as protocol agreement or preconfiguration, so that the terminal can implement receiving of the CSI-RS and determining of the CSI corresponding to the N second ports.

In an implementation, for a case in which the network side device indicates the first mapping relationship, the first mapping relationship may be indicated by at least one of a bitmap (Bitmap) and second indication information, without limitation.

The bitmap may include but is not limited to at least one of a first bitmap, a second bitmap, a third bitmap, and a fourth bitmap.

A length of the first bitmap is N1, and the first bitmap is used to indicate a mapping relationship between the second port and the first port in the horizontal dimension.

A length of the second bitmap is N2, and the second bitmap is used to indicate a mapping relationship between the second port and the first port in a vertical dimension.

It may be understood that for the first bitmap and the second bitmap, it is assumed that the network side device indicates both the first bitmap and the second bitmap. In this case, it is assumed that in an antenna pattern of the network side device (for example, a base station), there are N1=8 second ports in the horizontal dimension, N2=4 second ports in the vertical dimension, and a total quantity of second ports is 8*4*2=64. In this case, in this application, to reduce actual CSI-RS resource overheads, 4*2*2=16 actual transmit ports (the foregoing first port) may be determined. For example, if the network side device performs sending only on even-numbered port indexes in the horizontal dimension, actual transmit ports are [0, 2, 4, 6], which is corresponding to M1=4; and if the network side device performs sending only on even-numbered port indexes in the vertical dimension, actual transmit ports are [0, 2], which is corresponding to M2=2. In other words, the first bitmap and the second bitmap may be represented as [1 0 1 0 1 0 1 0] and [1 0 1 0] respectively, where “1” indicates sending, and “0” indicates not sending.

A length of the third bitmap is N1*N2. In this embodiment, for the third bitmap, the third bitmap may be used to indicate a mapping relationship between a second port and a first port in each polarized antenna group in a dual-polarized antenna group, that is, a port pattern is shared in two polarization directions.

Alternatively, the third bitmap is used to indicate a mapping relationship between a second port and a first port in a specific polarized antenna group in a dual-polarized antenna group. In other words, the third bitmap indicates that only one type of polarized antenna group is available, and in the other type of polarized antenna group, all second ports and all first ports are in one-to-one mapping by default. Optionally, the specific polarized antenna group may be determined in a manner such as protocol agreement or higher layer indication. This is not limited herein.

A length of the fourth bitmap is N1*N2*2, and the fourth bitmap is used to indicate a mapping relationship between a second port and a first port in a dual-polarized antenna group. For example, in the fourth bitmap, a bit indicated as 1 represents that a corresponding second port is activated and regarded as the first port, while a bit indicated as 0 represents that a corresponding second port cannot be mapped to the first port.

It should be noted that the third bitmap and the fourth bitmap have relatively large signaling overheads than several bitmap indication manners provided in the foregoing solution, but can more flexibly indicate any selection mapping relationship.

The second indication information is used to indicate that one of a plurality of mapping relationships that are preconfigured or that are agreed upon in a protocol is the first mapping relationship. The first mapping relationship may indicate different combination states by using different bits (bit) in the second indication information. For example, it is assumed that the plurality of mapping relationships that are preconfigured or that are agreed upon in a protocol are shown in Table 1. In this case, the network side device may indicate different first mapping relationships by using the second indication information. In addition, an index in Table 1 is a port index.

For ease of description in this application, only one CSI-RS resource configuration is listed above. However, generally, for a case in which one CSI report (report) is associated with a plurality of CSI-RS resources, the first mapping relationship may be shared by all the CSI-RS resources associated with the CSI report, or different mapping relationships may be configured for different CSI-RS resources. This is not limited herein.

It should be noted that, to improve application flexibility of the CSI determining solution provided in this application, for the first mapping relationship mentioned in this application, a moment at which the first mapping relationship is activated or takes effect may be implemented in a manner such as protocol agreement or higher layer configuration. For example, if the CSI-RS (for example, the CSI-RS) is a reference signal received at a specific moment (for example, a periodic or several receiving moments) configured in the CSI-RS resource, it may be determined that the first mapping relationship takes effect or is activated. In other words, it is determined that the first mapping relationship takes effect or is activated if the CSI-RS is received at a specific moment in the CSI-RS resource.

For example, the CSI-RS is configured to be sent periodically, and indicates, by using higher layer signaling, that the first mapping relationship takes effect or is activated at a specific moment, and the first mapping relationship takes effect or is activated or is in an inactive state at another sending moment except the specific moment. Therefore, time-frequency resource overheads occupied by the CSI-RS port can be reduced at the specific moment. For example, the terminal may determine CSI corresponding to all CSI-RS ports based on CSI-RSs corresponding to some CSI-RS ports at the specific moment.

TABLE 1

| Case (case) | Horizontal dimension | Vertical dimension |
|---|---|---|
| 0 | Second ports and first ports are in | Second ports and first ports are in |
| | one-to-one mapping | one-to-one mapping |
| 1 | Second ports and first ports are in | Even-numbered indexes of second ports |
| | one-to-one mapping | are in one-to-one mapping with first |
| | | ports, and odd-numbered indexes are |
| | | disabled |
| 2 | Even-numbered indexes of second | Second ports and first ports are in |
| | ports are in one-to-one mapping | one-to-one mapping |
| | with first ports, and odd-numbered | |
| | indexes are disabled | |
| 3 | Even-numbered indexes of second | Even-numbered indexes of second ports |
| | ports are in one-to-one mapping | are in one-to-one mapping with first |
| | with first ports, and odd-numbered | ports, and odd-numbered indexes are |
| | indexes are disabled | disabled |
| 4 | Odd-numbered indexes of second | Odd-numbered indexes of second ports |
| | ports are in one-to-one mapping | are in one-to-one mapping with first |
| | with first ports, and even-numbered | ports, and even-numbered indexes are |
| | indexes are disabled | disabled |
| 5 | Even-numbered indexes of second | Odd-numbered indexes of second ports |
| | ports are in one-to-one mapping | are in one-to-one mapping with first |
| | with first ports, and odd-numbered | ports, and even-numbered indexes are |
| | indexes are disabled | disabled |
| 6 | Odd-numbered indexes of second | Even-numbered indexes of second ports |
| | ports are in one-to-one mapping | are in one-to-one mapping with first |
| | with first ports, and even-numbered | ports, and odd-numbered indexes are |
| | indexes are disabled | disabled |

In another implementation, the first mapping relationship is related to first capability information of the terminal. The first capability information is used to indicate a capability of supporting a second quantity of first ports by the terminal when the terminal is configured with a first quantity of second ports, and a mapping relationship (or a ratio relationship) between the second quantity of first ports and the first quantity of second ports. For example, “the first mapping relationship is related to first capability information of the terminal” may be understood as that the first mapping relationship may be determined based on the first capability information. Therefore, it can be ensured that the first mapping relationship matches a capability of the terminal, so that the terminal accurately determines the CSI of the N second ports based on the CSI-RSs corresponding to the M first ports.

It should be noted that the first mapping relationship may be consistent or inconsistent with a quantity of first ports, a quantity of second ports, a mapping relationship, or a ratio relationship that is indicated by the first capability information. This is not limited herein.

In a possible implementation, the terminal may further send second capability information to the network side device, so that the network side device knows a maximum quantity of ports of a total of a plurality of activated CSI-RSs that can be processed by the terminal in any time domain unit (such as a slot (slot)).

Optionally, the second capability information is used to indicate at least one of the following (11) to (13).

(11) A maximum quantity of ports, where the maximum quantity of ports is obtained by counting first ports or second ports in all activated CSI-RS resources that are processed by the terminal in any time domain unit (such as a slot (slot)) and associated with a CSI report.

For (11), an implementation of counting a maximum quantity of ports of a total of a plurality of activated CSI-RS s (a plurality of CSI-RSs may be associated with different CSI reports or a same CSI-RS may be associated with different CSI reports) is as follows: If a port of one corresponding CSI-RS is configured with the first port, counting is performed based on the quantity M of first ports; or although the first port is configured, counting is performed based on the quantity N of second ports associated with the CSI report.

(12) A quantity of first ports in all activated CSI-RS resources that are processed by the terminal in any time domain unit and associated with a CSI report.

For (12), the terminal may report a maximum quantity of ports that can be supported when counting is performed based only on a quantity of first ports configured on all activated CSI-RS resources.

(13) A quantity of second ports in all activated CSI-RS resources that are processed by the terminal in any time domain unit and associated with a CSI report.

For (13), the terminal may report a maximum quantity of ports that can be supported when counting is performed based only on a quantity of second ports configured on all activated CSI-RS resources.

Based on the foregoing description of the CSI determining method 300, the following describes an implementation process of the CSI determining method with reference to an example, and content is as follows:

### Example 1

The terminal receives first indication information (for example, CSI report signaling), where CSI-resourceConfig is configured in the CSI report signaling, and an associated CSI-RS resource ID is indicated in a CSI-resource. In addition, a format corresponding to a codebook (codebook) report is also configured in the CSI report signaling, including a corresponding antenna pattern of a base station, for example, a quantity N1 of CSI-RS ports (the foregoing second port) in the horizontal dimension and a quantity N2 of CSI-RS ports (the foregoing second port) in the vertical dimension, when CSI is calculated based on the CSI-RS resource. For a dual-polarized antenna array, a total quantity of second ports is N1*N2*2.

In this case, the terminal needs to refer to values of N1 and N2 in a process of calculating the CSI of the second port. For example, when spatial domain information of a codebook in the CSI is calculated, when a discrete Fourier transform (Discrete Fourier Transform, DFT) base is used to represent a spatial domain beam, N1 and N2 respectively correspond to a DFT base length in the horizontal dimension and a DFT base length in the vertical dimension.

The network side device also configures a quantity of actual transmit ports (the foregoing first port) of the CSI-RS resource associated with the codebook, for example, a quantity M1 of CSI-RS actual ports in the horizontal dimension and a quantity M2 of CSI-RS ports in the vertical dimension. Therefore, for the dual-polarized antenna array, a total quantity of second ports is N1*N2*2. In this application, to reduce CSI-RS resource overheads, the quantity M1 of first ports in the horizontal dimension is less than or equal to N1, or the quantity M2 of first ports in the vertical dimension is less than or equal to N2.

Finally, the terminal receives the CSI-RS on the first port of the CSI-RS resource and measures a channel to obtain channel measurement information, which may be denoted as a CSI-RS. In addition, the terminal obtains measurement channel information on the second port of the CSI-RS resource based on the CSI-RS corresponding to the first port, and calculates CSI corresponding to the second port based on the measurement channel information on the second port and a CSI report type. For example, for a physical downlink shared channel (Physical downlink shared channel, PDSCH) based on a codebook sending formula, as shown in formula (1), spatial domain information of a codebook in CSI may be obtained, where p is a quantity of second ports.

$$[ \begin{matrix}{y}^{( 3000 )} ( i ) \\ … \\ {y}^{( 3000 + P - 1 )} ( i )\end{matrix} ] = W ( i ) [ \begin{matrix}{x}^{( 0 )} ( i ) \\ … \\ {x}^{( v - 1 )} ( i )\end{matrix} ] \qquad ( 1 )$$

In this embodiment of this application, the terminal indicates the pattern of the CSI-RS resource and the first mapping relationship by using a design of CSI-RS ports distributed in a discrete manner in spatial domain, so that accuracy of determining the CSI corresponding to the N second ports by the terminal can be further improved.

As shown in FIG. 4, FIG. 4 is a schematic flowchart of a channel state information determining method 400 according to an example embodiment of this application. The method 400 may be performed by a terminal, without limitation, and may be specifically performed by hardware or software installed in the terminal. In this embodiment, the method 400 may include at least the following steps.

S410: The terminal determines CSI corresponding to N second ports based on CSI-RSs corresponding to M first ports.

S420: Send the CSI corresponding to the N second ports to a network side device.

The N second ports are CSI-RS ports configured by the network side device for the terminal, and the M first ports are some ports in the N second ports.

It may be understood that, for an implementation process of S410 and S420, reference may be made to related descriptions in the foregoing method embodiment 200 or 300. Certainly, in addition to related descriptions in the foregoing method embodiment 200 or 300, as a possible implementation, referring to FIG. 4 again, an implementation process of S410 may include S411 shown in FIG. 4, and content is as follows.

S411: Estimate the CSI corresponding to the N second ports based on the CSI-RSs corresponding to the M first ports and a spatial-domain filtering coefficient.

The spatial-domain filtering coefficient may be obtained in a plurality of manners. For example, in this embodiment, the spatial-domain filtering coefficient may be obtained in at least one of the following manner 1 to manner 4.

Manner 1: The terminal obtains the spatial-domain filtering coefficient through measurement based on a first downlink RS. The first downlink RS is the CSI-RS, or the first downlink RS is associated with the CSI report, which may also be understood as that the terminal obtains the spatial-domain filtering coefficient based on the CSI-RS itself.

It may be understood that a process in which the terminal obtains the spatial-domain filtering coefficient through measurement based on the first downlink RS may include: The terminal obtains spatial domain-related information (for example, spatial domain correlation and a spatial domain spectrum) or an inter-port cross-correlation matrix of a wireless channel through measurement based on the first downlink RS, where for the spatial domain-related information, the terminal may determine the cross-correlation matrix based on the spatial domain-related information, and then obtain the spatial-domain filtering coefficient W_filter based on the cross-correlation matrix and a minimum mean square error (Minimum Mean Square Error, MMSE) criterion in a wiener filtering algorithm. For example, this is shown in the following formula (2):

$$W\_filter = Rn , m * inv ( R m , m + δ2 * 1 ) \qquad ( 2 )$$

In formula (2), Rm,m represents a cross-correlation matrix between CSI-RS ports that is used by the terminal to receive the first downlink RS, a size of Rm,m is m×m, and a value of m depends on an implementation of the terminal. Rn,m represents a cross-correlation matrix between a to-be-estimated CSI-RS port and a CSI-RS port used for receiving the first downlink RS, a size of Rn,m is n×m, and a value of n also depends on an implementation of the terminal. δ2 represents average interference and noise power in a receiver on a terminal side, and I represents a unit matrix. It may be understood that in the manner 1, because the first downlink RS is the CSI-RS, the CSI-RS port used for receiving the first downlink RS is the first port, and the to-be-estimated CSI-RS port is the second port.

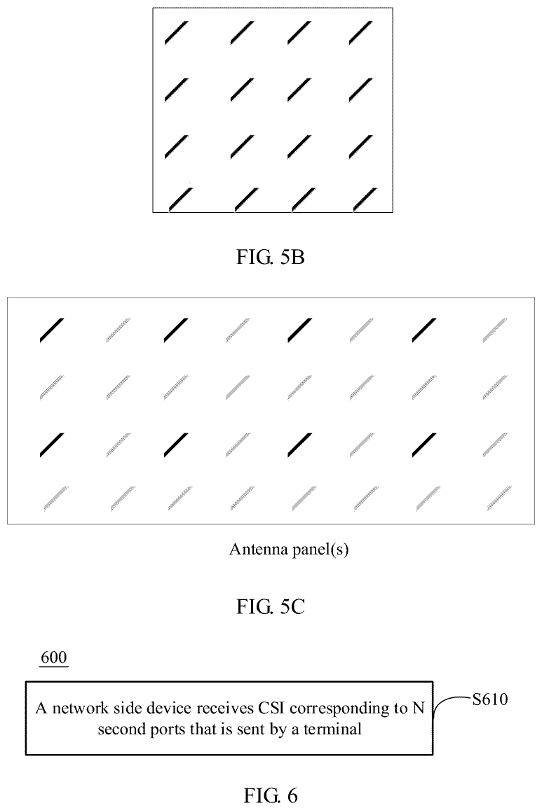

For example, as shown in FIG. 5A, only half of first ports and second ports on one antenna panel on the network side device (for example, a base station) are in one-to-one mapping (corresponding to a left part in FIG. 5A), and the other half of first ports are a subset of the second ports. A spacing is used for one-to-one mapping in the horizontal direction and the vertical direction (a solid black part indicates that a logical transmit port and an actual transmit port are in one-to-one mapping, and a virtual black part indicates that the logical transmit port is disabled and is not mapped to the actual transmit port). Herein, a quantity of actual transmit ports is the quantity of first ports, and a quantity of logical transmit ports is the quantity of second ports. In this case, the terminal may calculate a spatial-domain filtering coefficient in the horizontal dimension, the vertical dimension, or a joint two-dimensional horizontal-vertical domain on an antenna panel based on an inter-port cross-correlation matrix of a wireless channel corresponding to a CSI-RS (the foregoing first downlink RS) sent by a left-side 4×4 antenna port. Then, the terminal obtains channel measurement information (such as channel estimation information) of the first port through estimation based on a CSI-RS corresponding to the first port (for example, a solid black part), to filter out channel measurement information corresponding to the second port by combining calculated spatial-domain filtering coefficients, and finally obtains CSI report information, that is, CSI, based on the channel measurement information corresponding to the second port. Generally, a left antenna part and a right antenna part may correspond to different antenna panels of the base station, and the two panels face a same direction and may have a same spatial-domain filtering coefficient, but the two panels have a specific antenna spacing.

In addition, in the manner 1, when the first downlink RS is the CSI-RS, the CSI-RS is configured with periodic sending, and higher layer signaling indicates that at a specific moment, a quantity of ports configured for the CSI-RS corresponds to the second port, and at another sending moment, a quantity of ports configured for the CSI-RS corresponds to the first port. The terminal may obtain the spatial-domain filtering coefficient based on CSI-RS full-channel information at a specific moment, and further derive full-channel information, that is, CSI, based on the spatial-domain filtering coefficient obtained by using the CSI-RS at another sending moment.

In addition, when the terminal calculates, based on one of the CSI-RS resources, a spatial-domain filtering coefficient that is used to perform spatial filtering on another CSI-RS resources, the CSI-RS resources have a same QCL relationship.

Manner 2: The terminal obtains the spatial-domain filtering coefficient through measurement based on a second downlink RS. For example, the terminal may obtain, through measurement based on the second downlink RS, spatial domain-related information (such as spatial domain correlation and spatial domain spectrum) or an inter-port cross-correlation matrix corresponding to a wireless channel, and then determines the spatial-domain filtering coefficient based on the spatial domain-related information.

The second downlink RS may be a multi-port RS separately configured by the network side device. Optionally, the second downlink RS may be further extended based on a TRS (Tracking Reference Signal) in a 5G NR protocol. For example, the second downlink RS is a TRS configured with a plurality of ports. Based on the TRS, the terminal not only obtains a wireless channel features QCL type A, QCL type B, QCL type C, or QCL type D, but also obtains a base station transmit spatial feature. Herein, the spatial-domain filtering coefficient may be derived based on the spatial feature.

Optionally, a port pattern corresponding to the second downlink RS may be a subset or a full set of a pattern of the second port. The full set indicates that an actual transmit port of the second downlink RS and the second port are in a one-to-one mapping relationship in a same polarization direction. The subset indicates that an actual transmit port of the second downlink RS and the second port are in a partially contiguous one-to-one mapping relationship in a same polarization direction, and the partially contiguous one-to-one mapping relationship is indicated in a manner such as network higher layer signaling configuration. For example, the network side device may configure a time-frequency resource and a sending period that are corresponding to one second downlink RS, and a corresponding antenna sending port pattern is shown in FIG. 5B. In addition, the network side device may further configure, by using the first indication information, the second port and the first port that are associated in the CSI-Report, as shown in FIG. 5C.

It may be understood that for a related process in which the terminal determines the spatial-domain filtering coefficient based on the second downlink RS, reference may be made to related descriptions in the foregoing manner 1, and details are not described herein again.

In an implementation, when the terminal obtains the spatial-domain filtering coefficient through measurement based on the foregoing second downlink RS, a transmission configuration indicator (Transmission Configuration Indicator, TCI) state (state) quasi co-location reference signal corresponding to the CSI-RS includes the second downlink RS, or the CSI-RS and the second downlink RS have a same TCI state quasi co-location reference signal. In other words, the CSI-RS resources need to be QCLed to the second downlink RS, or both the CSI-RS resources and the second downlink RS are QCLed to a same TCI state ID, to ensure matching between the spatial-domain filtering coefficient determined based on the second downlink RS and the CSI-RS determined based on the CSI-RS, thereby improving accuracy of determining the CSI corresponding to the second port.

Manner 3: The terminal obtains the spatial-domain filtering coefficient through measurement based on a third downlink RS. The third downlink RS is a precoding (Precoding) RS that is sent by the network side device and that is subjected to beamforming or delay compensation. Correspondingly, the terminal receives RSs that undergo different precoding and obtains spatial domain-related information (for example, a spatial domain power spectrum) or an inter-port cross-correlation matrix corresponding to a wireless channel, to obtain the spatial-domain filtering coefficient based on the spatial domain power spectrum or the cross-correlation matrix.

For example, the network side device (for example, a base station) may obtain several primary beam features of a downlink channel based on some prior information, and send a CSI-RS (the foregoing third downlink RS) of precoding, where precoding information may be based on a feature vector obtained through singular value decomposition (Singular Value Decomposition, SVD). For example, in an enhanced TypeII-codebook supported in the discussions of the Rel17 protocol, processing behavior of the base station may also be DFT-based precoding. The terminal receives a corresponding CSI-RS port, obtains a spatial domain power spectrum, and obtains a spatial domain-related coefficient, such as the spatial-domain filtering coefficient, through Fourier transform, to perform filtering processing.

In an implementation, when the terminal obtains the spatial-domain filtering coefficient through measurement based on the foregoing third downlink RS, the TCI state quasi co-location reference signal corresponding to the CSI-RS includes the third downlink RS, or the CSI-RS and the third downlink RS have a same TCI state quasi co-location reference signal. In other words, the CSI-RS resources need to be QCLed to the third downlink RS, or both the CSI-RS resources and the third downlink RS are QCLed to a same TCI state ID, to ensure matching between the spatial-domain filtering coefficient determined based on the third downlink RS and the CSI-RS determined based on the CSI-RS, thereby improving accuracy of determining the CSI corresponding to the second port.

It may be understood that for a related process in which the terminal determines the spatial-domain filtering coefficient based on the third downlink RS, reference may be made to related descriptions in the foregoing manner 1, and details are not described herein again.

Manner 4: The terminal receives a spatial-domain filtering coefficient sent by the network side device.

The spatial-domain filtering coefficient may be obtained by the network side device based on uplink channel measurement, for example, sounding reference signal (Sounding Reference Signal, SRS) measurement.

Optionally, a spatial relation (spatial relation) of the SRS and the CSI-RS can be QCLed to a same TCI state indication relationship (for example, the spatial relation of the SRS and the CSI-RS can be both QCLed to a same CSI-RS or synchronization signal and PBCH block (Synchronization Signal and PBCH block, SSB) index), or a downlink reference signal associated with the spatial relation of the SRS is the CSI-RS itself.

Optionally, a QCL type in the foregoing spatial relation TCI state/TCI states of QCL includes at least one newly introduced QCL type, which is used to indicate the spatial-domain filtering coefficient sent by the network side device. For example, QCL ‘typeE’: {Spatial Tx parameter}. Therefore, accuracy of determining the spatial-domain filtering coefficient can be implemented by introducing a new QCL type.

Based on this, in an implementation, for a same understanding of the spatial-domain filtering coefficient between the terminal and the network side device, to enable the terminal to accurately receive the spatial-domain filtering coefficient, in this embodiment, when the spatial-domain filtering coefficient is sent by the network side device, the spatial-domain filtering coefficient is indicated or represented by at least one of the following (21) to (27).
(21) K1×1 vector, used to represent a correlation between inter-index differences of K1 second antenna ports in the horizontal dimension, where K1 is less than N1.
(22) K2×1 vector, used to represent a correlation between inter-index differences of K2 second antenna ports in the vertical dimension, where K2 is less than N2.
(23) K1×K2 two-dimensional correlation matrix, used to represent an autocorrelation matrix of inter-index differences between K1 second antenna ports in the horizontal dimension and K2 second antenna ports in the vertical dimension, where K1 is less than N1, and K2 is less than N2.
(24) Beam index.
(25) Discrete Fourier transform DFT basis index.
(26) Relative power differences corresponding to different beam indexes.
(27) Relative power differences corresponding to different DFT basis indexes.

For (24) to (27), the beam index or the DFT basis index may correspond to an indication or representation of the spatial-domain filtering coefficient in the horizontal dimension (or the vertical dimension).

Based on the manners of obtaining the spatial-domain filtering coefficient provided in the foregoing manner 1 to the manner 4, a process in which the terminal determines, after obtaining the spatial-domain filtering coefficient, to perform CSI estimation based on the spatial-domain filtering coefficient may include: The terminal obtains bare channel measurement information H_est through channel estimation based on a CSI-RS configured with the first port, and then performs filtering on the bare channel measurement information based on the obtained spatial-domain filtering coefficient W_filter to obtain channel measurement information H_filter corresponding to the CSI-RS of the second port, and then determines CSI based on the channel measurement information H_filter, for example, as shown in formula (3).

$$H\_filter ( p ) = W\_filter * H\_ est ( k + [ 1 : m ] ) \qquad ( 3 )$$

In the formula (3), H_filter (p) represents channel measurement information obtained after an index p of the second port is filtered, and H_est(k+[1:m]) represents channel measurement information corresponding to m ports when an index of the first port is (k+[1:m]).

In an implementation process of the terminal, p is associated with k, and a purpose of association is to perform filtering on m adjacent first ports by using the index p of the second port.

In an implementation, considering that the spatial-domain filtering coefficient is introduced during determining of the CSI of the N second ports in this application, to ensure that the CSI processing unit can support implementation of this CSI determining process, CSI processing performance may be enhanced. For example, in this embodiment, a quantity of CSI processing units that may be associated with the CSI report is related to first information, and the first information is a ratio of the quantity of second ports to the quantity of first ports. For example, if the ratio is N/M, it is determined that the quantity of CSI processing units is related to a value of N/M.

For another example, the quantity of CSI processing units associated with the CSI report is determined based on a quantity of first CSI processing units and a predetermined value, and the first CSI processing unit is a CSI unit used when the terminal determines, based on CSI-RSs corresponding to the N second ports, CSI corresponding to the N second ports. For example, when the terminal determines the CSI corresponding to the N second ports based on the CSI-RSs corresponding to the N second ports, a quantity of used first CSI processing units is S, and in this case, when the terminal determines the CSI in the manner of “estimating the second CSI corresponding to the N second ports based on first CSI corresponding to the M first ports and the spatial-domain filtering coefficient”, the CSI corresponding to the N second ports, the quantity of used second CSI processing units used is S+a predetermined value, where the predetermined value is a positive number, such as 1, 2, or 3, which may be implemented in a manner such as protocol agreement, higher layer configuration, or network side configuration.

In addition, “the terminal determines the CSI corresponding to the N second ports based on the CSI-RSs corresponding to the N second ports” may be understood as follows: The terminal determines and measures, based on the N second ports, the CSI-RS sent by the network side device, and determines the CSI corresponding to the N second ports based on a channel measurement result.

In another implementation, a target parameter configured in the CSI-RS resource associated with the CSI report is associated with the second port, where the target parameter includes a power control offset (power Control offset). In other words, in an implementation process of this solution, parameters such as the power control offset are defined based on the second port, so that this application can be better integrated and applied with the technology in a related technology, and applicability of this solution is improved.

In this embodiment of this application, the terminal performs full-channel information recovery by using a design of CSI-RS ports distributed in a discrete manner in spatial domain and by using spatial domain correlation between adjacent ports of a large-array antenna, so that a pilot overheads problem caused by an increase in CSI-RS resource ports of an extremely large aperture array can be resolved, and the network performance is ensured.

As shown in FIG. 6, FIG. 6 is a schematic flowchart of a channel state information determining method 600 according to an example embodiment of this application. The method 600 may be performed by a network side device, without limitation, and may be specifically performed by hardware or software installed in the network side device. In this embodiment, the method 600 may include at least the following steps.

S610: The network side device receives CSI corresponding to N second ports that is sent by a terminal.

The CSI corresponding to the N second ports is determined based on channel state information reference signals CSI-RSs corresponding to M first ports, the N second ports are CSI-RS ports configured by the network side device for the terminal, and the M first ports are some ports in the N second ports.

Optionally, the method includes: The network side device sends first indication information to the terminal, where the first indication information includes at least one of the following: a pattern of a CSI-RS resource, where the pattern of the CSI-RS resource includes M1 first ports in the horizontal dimension, M2 first ports in the vertical dimension, N1 second ports in the horizontal dimension, and N2 second ports in the vertical dimension; and a first mapping relationship, where a mapping relationship between the N1 second ports and the M1 first ports or a mapping relationship between the N2 second ports and the M2 first ports is configured in the first mapping relationship.

Optionally, the first mapping relationship is indicated by at least one of the following: a bitmap; and second indication information used to indicate that one of a plurality of mapping relationships that are preconfigured or that are agreed upon in a protocol is the first mapping relationship.

Optionally, the bitmap includes at least one of the following: a first bitmap, where a length of the first bitmap is N1, and the first bitmap is used to indicate a mapping relationship between the second port and the first port in the horizontal dimension; a second bitmap, where a length of the second bitmap is N2, and the second bitmap is used to indicate a mapping relationship between the second port and the first port in the vertical dimension; a third bitmap, where a length of the third bitmap is N1*N2, and the third bitmap is used to indicate a mapping relationship between a second port and a first port in each polarized antenna group in a dual-polarized antenna group, or the third bitmap is used to indicate a mapping relationship between a second port and a first port in a specific polarized antenna group in a dual-polarized antenna group; and a fourth bitmap, where a length of the fourth bitmap is N1*N2*2, and the fourth bitmap is used to indicate a mapping relationship between a second port and a first port in a dual-polarized antenna group.

Optionally, the method further includes at least one of the following: sending a first downlink reference signal RS to the terminal, where the first downlink RS is the CSI-RS; sending a second downlink RS to the terminal, where the second downlink RS is a multi-port RS, and the second downlink RS is different from the CSI-RS; sending a third downlink RS to the terminal, where the third downlink RS is a precoding RS subjected to beamforming or delay compensation; and sending a spatial-domain filtering coefficient to the terminal, where the spatial-domain filtering coefficient is obtained based on uplink channel measurement, and the first downlink RS, the second downlink RS, or the third downlink RS is used by the terminal to determine the spatial-domain filtering coefficient.

Optionally, when the network side device sends the spatial-domain filtering coefficient to the terminal, the spatial-domain filtering coefficient is indicated or represented by at least one of the following: a K1×1 vector, used to represent a correlation between inter-index differences of K1 second antenna ports in the horizontal dimension, where K1 is less than N1; a K2×1 vector, used to represent a correlation between inter-index differences of K2 second antenna ports in the vertical dimension, where K2 is less than N2; a K1×K2 two-dimensional correlation matrix, used to represent an autocorrelation matrix of inter-index differences between K1 second antenna ports in the horizontal dimension and K2 second antenna ports in the vertical dimension, where K1 is less than N1, and K2 is less than N2; a beam index; a discrete Fourier transform DFT basis index; a relative power difference corresponding to different beam indexes; and a relative power difference corresponding to different DFT basis indexes.

Optionally, the method further includes: receiving second capability information sent by the terminal, where the second capability information is used to indicate at least one of the following: a maximum quantity of ports, where the maximum quantity of ports is obtained by counting first ports or second ports in all activated CSI-RS resources that are processed by the terminal in any time domain unit and associated with a CSI report; a quantity of first ports in all activated CSI-RS resources that are processed by the terminal in any time domain unit and associated with a CSI report; and a quantity of second ports in all activated CSI-RS resources that are processed by the terminal in any time domain unit and associated with a CSI report.

It may be understood that an implementation process of the implementations in the method embodiment 600 has a same or corresponding technical feature as that in the foregoing method embodiments 200 to 400. Therefore, for an implementation process of the implementations in the method embodiment 600, reference may be made to related descriptions in the foregoing method embodiments 200 to 400, and a same or corresponding technical effect can be achieved. To avoid repetition, details are not described herein again.

The channel state information determining method provided in the embodiments of this application may be performed by a channel state information determining apparatus. In the embodiments of this application, the channel state information determining apparatus provided in the embodiments of this application is described by using an example in which the channel state information determining method is performed by the channel state information determining apparatus.

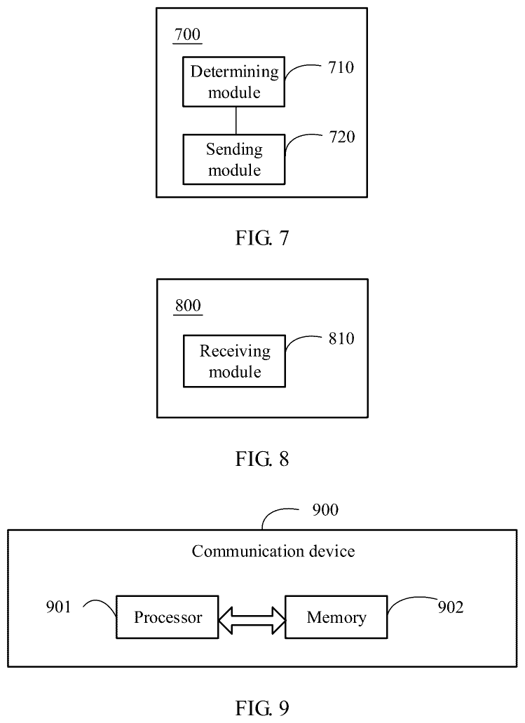

As shown in FIG. 7, FIG. 7 is a schematic structural diagram of a channel state information determining apparatus 700 according to an embodiment of this application. The apparatus 700 includes: a determining module 710, configured to determine CSI corresponding to N second ports based on channel state information reference signals CSI-RSs corresponding to M first ports; and a sending module 720, configured to send the CSI corresponding to the N second ports to a network side device; where the N second ports are CSI-RS ports configured by the network side device for the terminal, and the M first ports are some ports in the N second ports.

Optionally, the first port is mapped in a same polarization direction to M1 ports in a horizontal dimension and M2 ports in a vertical dimension, the second port is mapped in a same polarization direction to N1 ports in the horizontal dimension and N2 ports in the vertical dimension, M1 is less than or equal to N1, or M2 is less than or equal to N2, M1, M2, N1, and N2 each are an integer greater than 0, M=M1*M2*2, and N=N1*N2*2.

Optionally, the apparatus 700 further includes a receiving module, configured to receive first indication information sent by the network side device. The first indication information includes or indicates at least one of the following: a pattern of a CSI-RS resource, where the pattern of the CSI-RS resource includes M1 first ports in the horizontal dimension, M2 first ports in the vertical dimension, N1 second ports in the horizontal dimension, and N2 second ports in the vertical dimension; and a first mapping relationship, where a mapping relationship between the N1 second ports and the M1 first ports or a mapping relationship between the N2 second ports and the M2 first ports is configured in the first mapping relationship.

Optionally, the first mapping relationship is indicated by at least one of the following: a bitmap; and second indication information used to indicate that one of a plurality of mapping relationships that are preconfigured or that are agreed upon in a protocol is the Optionally, the bitmap includes at least one of the following: a first bitmap, where a length of the first bitmap is N1, and the first bitmap is used to indicate a mapping relationship between the second port and the first port in the horizontal dimension; a second bitmap, where a length of the second bitmap is N2, and the second bitmap is used to indicate a mapping relationship between the second port and the first port in the vertical dimension; a third bitmap, where a length of the third bitmap is N1*N2, and the third bitmap is used to indicate a mapping relationship between a second port and a first port in each polarized antenna group in a dual-polarized antenna group, or the third bitmap is used to indicate a mapping relationship between a second port and a first port in a specific polarized antenna group in a dual-polarized antenna group; and a fourth bitmap, where a length of the fourth bitmap is N1*N2*2, and the fourth bitmap is used to indicate a mapping relationship between a second port and a first port in a dual-polarized antenna group.

Optionally, the determining module 710 is further configured to: when the CSI-RS is received at a specific moment in the CSI-RS resource, determine that the first mapping relationship takes effect or is activated.

Optionally, the first mapping relationship is related to first capability information of the terminal, where the first capability information is used to indicate that the terminal supports a second quantity of first ports when the terminal is configured with and a mapping relationship or a ratio relationship between the second quantity of first ports and the first quantity of second ports.

Optionally, that the determining module 710 determines the CSI corresponding to the N second ports based on the CSI-RSs corresponding to the M first ports includes: estimating the CSI corresponding to the N second ports based on the CSI-RSs corresponding to the M first ports and a spatial-domain filtering coefficient.

Optionally, the spatial-domain filtering coefficient is obtained in at least one of the following manners: being obtained based on a first downlink RS through measurement, where the first downlink RS is the CSI-RS; being obtained based on a second downlink RS through measurement, where the second RS is a multi-port RS, and the second downlink RS is different from the CSI-RS; being obtained based on a third downlink RS through measurement, where the third downlink RS is a precoding RS subjected to beamforming or delay compensation; and receiving a spatial-domain filtering coefficient sent by the network side device.

Optionally, a port pattern corresponding to the second downlink RS is a subset or a full set of a pattern of the second port.

Optionally, when the terminal obtains the spatial-domain filtering coefficient through measurement based on the second downlink RS or the third downlink RS, a TCI state quasi co-location reference signal corresponding to the CSI-RS includes the second downlink RS or the third downlink RS, or the CSI-RS has a same TCI state quasi co-location reference signal as the second downlink RS or the third downlink RS.

Optionally, when the spatial-domain filtering coefficient is sent by the network side device, the spatial-domain filtering coefficient is indicated or represented by at least one of the following: a K1×1 vector, used to represent a correlation between inter-index differences of K1 second antenna ports in the horizontal dimension, where K1 is less than N1; a K2×1 vector, used to represent a correlation between inter-index differences of K2 second antenna ports in the vertical dimension, where K2 is less than N2; a K1×K2 two-dimensional correlation matrix, used to represent an autocorrelation matrix of inter-index differences between K1 second antenna ports in the horizontal dimension and K2 second antenna ports in the vertical dimension, where K1 is less than N1, and K2 is less than N2; a beam index; a discrete Fourier transform DFT basis index; a relative power difference corresponding to different beam indexes; and a relative power difference corresponding to different DFT basis indexes.

Optionally, the sending module 720 is further configured to send second capability information to the network side device, where the second capability information is used to indicate at least one of the following: a maximum quantity of ports, where the maximum quantity of ports is obtained by counting first ports or second ports in all activated CSI-RS resources that are processed by the terminal in any time domain unit and associated with a CSI report; a quantity of first ports in all activated CSI-RS resources that are processed by the terminal in any time domain unit and associated with a CSI report; and a quantity of second ports in all activated CSI-RS resources that are processed by the terminal in any time domain unit and associated with a CSI report.

Optionally, at least one of the following is satisfied: a quantity of CSI processing units associated with the CSI report is related to first information, and the first information is a ratio of the quantity of second ports to the quantity of first ports; the quantity of CSI processing units associated with the CSI report is determined based on a quantity of first CSI processing units and a predetermined value, and the first CSI processing unit is a CSI unit used when the terminal determines the CSI corresponding to the N second ports based on CSI-RSs corresponding to the N second ports; and a target parameter configured in a CSI-RS resource associated with the CSI report is associated with the second port, where the target parameter includes a power control offset.

The channel state information determining apparatus 700 in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (Network Attached Storage, NAS), or the like. This is not specifically limited in this embodiment of this application.

The channel state information determining apparatus 700 provided in this embodiment of this application can implement the processes in the method embodiments in FIG. 2 to FIG. 4, and a same technical effect is achieved. To avoid repetition, details are not described herein again.

As shown in FIG. 8, FIG. 8 is a schematic structural diagram of a channel state information determining apparatus 800 according to an embodiment of this application. The apparatus 800 includes a receiving module 810, configured to receive channel state information CSI corresponding to N second ports that is sent by a terminal, where the CSI corresponding to the N second ports is determined based on channel state information reference signals CSI-RSs corresponding to M first ports, the N second ports are CSI-RS ports configured by a network side device for the terminal, and the M first ports are some ports in the N second ports.

Optionally, the apparatus 800 further includes a sending module, configured to send first indication information to a terminal, where the first indication information includes or indicates at least one of the following: a pattern of a CSI-RS resource, where the pattern of the CSI-RS resource includes M1 first ports in the horizontal dimension, M2 first ports in the vertical dimension, N1 second ports in the horizontal dimension, and N2 second ports in the vertical dimension; and a first mapping relationship, where a mapping relationship between the N1 second ports and the M1 first ports or a mapping relationship between the N2 second ports and the M2 first ports is configured in the first mapping relationship.

Optionally, the first mapping relationship is indicated by at least one of the following: a bitmap; and second indication information used to indicate that one of a plurality of mapping relationships that are preconfigured or that are agreed upon in a protocol is the Optionally, the bitmap includes at least one of the following: a first bitmap, where a length of the first bitmap is N1, and the first bitmap is used to indicate a mapping relationship between the second port and the first port in the horizontal dimension; a second bitmap, where a length of the second bitmap is N2, and the second bitmap is used to indicate a mapping relationship between the second port and the first port in the vertical dimension; a third bitmap, where a length of the third bitmap is N1*N2, and the third bitmap is used to indicate a mapping relationship between a second port and a first port in each polarized antenna group in a dual-polarized antenna group, or the third bitmap is used to indicate a mapping relationship between a second port and a first port in a specific polarized antenna group in a dual-polarized antenna group; and a fourth bitmap, where a length of the fourth bitmap is N1*N2*2, and the fourth bitmap is used to indicate a mapping relationship between a second port and a first port in a dual-polarized antenna group.

Optionally, the sending module is further configured to perform at least one of the following: sending a first downlink reference signal RS to the terminal, where the first downlink RS is the CSI-RS; sending a second downlink RS to the terminal, where the second downlink RS is a multi-port RS, and the second downlink RS is different from the CSI-RS; sending a third downlink RS to the terminal, where the third downlink RS is a precoding RS obtained after beamforming or delay compensation; and sending a spatial-domain filtering coefficient to the terminal, where the spatial-domain filtering coefficient is obtained through measurement based on an uplink channel, and the first downlink RS, the second downlink RS, or the third downlink RS is used by the terminal to determine the spatial-domain filtering coefficient.

Optionally, when the sending module 810 sends the spatial-domain filtering coefficient to the terminal, the spatial-domain filtering coefficient is indicated or represented by at least one of the following: a K1×1 vector, used to represent a correlation between inter-index differences of K1 second antenna ports in the horizontal dimension, where K1 is less than N1; a K2×1 vector, used to represent a correlation between inter-index differences of K2 second antenna ports in the vertical dimension, where K2 is less than N2; a K1×K2 two-dimensional correlation matrix, used to represent an autocorrelation matrix of inter-index differences between K1 second antenna ports in the horizontal dimension and K2 second antenna ports in the vertical dimension, where K1 is less than N1, and K2 is less than N2; a beam index; a discrete Fourier transform DFT basis index; a relative power difference corresponding to different beam indexes; and a relative power difference corresponding to different DFT basis indexes.

Optionally, the receiving module 810 is further configured to receive second capability information sent by the terminal, where the second capability information is used to indicate at least one of the following: a maximum quantity of ports, where the maximum quantity of ports is obtained by counting first ports or second ports in all activated CSI-RS resources that are processed by the terminal in any time domain unit and associated with a CSI report; a quantity of first ports in all activated CSI-RS resources that are processed by the terminal in any time domain unit and associated with a CSI report; and a quantity of second ports in all activated CSI-RS resources that are processed by the terminal in any time domain unit and associated with a CSI report.

The channel state information determining apparatus 800 in this embodiment of this application may be an electronic device, for example, an electronic device with an operating system, or may be a component in the electronic device, for example, an integrated circuit or a chip. The electronic device may be a network side device, or may be another device except a network side device. For example, the network side device may include but is not limited to the types of network side devices 12 listed above. This is not specifically limited in this embodiment of this application.

The channel state information determining apparatus 800 provided in this embodiment of this application can implement the process in the method embodiment in FIG. 6, and a same technical effect is achieved. To avoid repetition, details are not described herein again.

Optionally, as shown in FIG. 9, an embodiment of this application further provides a communication device 900, including a processor 901 and a memory 902, and the memory 902 stores a program or instructions capable of running on the processor 901. For example, in a case that the communication device 900 is a terminal, when the program or the instructions are executed by the processor 901, the steps of the foregoing embodiment of the channel state information determining method are implemented, and a same technical effect can be achieved. In a case that the communication device 900 is a network side device, when the program or the instructions are executed by the processor 901, the steps of the foregoing embodiment of the channel state information determining method are implemented, and a same technical effect can be achieved. To avoid repetition, details are not described herein again.

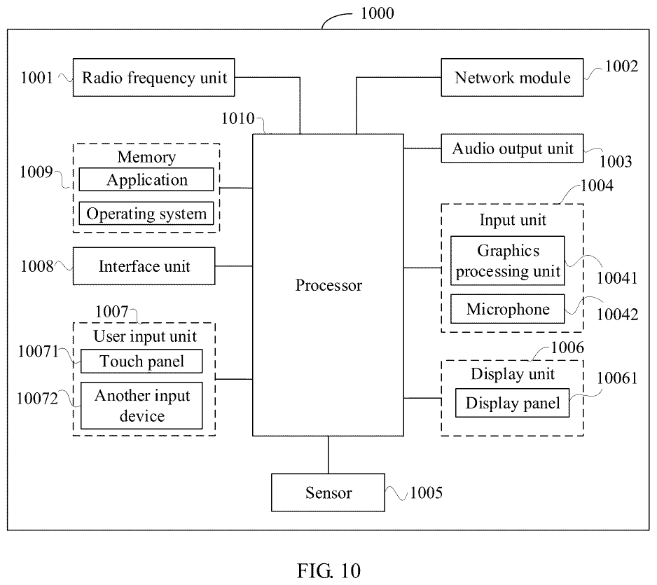

An embodiment of this application further provides a terminal, including a processor and a communication interface. The communication interface is coupled to the processor, and the processor is configured to run a program or instructions, to implement the steps in the method embodiments shown in FIG. 2 to FIG. 4. The terminal embodiment corresponds to the method embodiment on the terminal side, each implementation process and implementation manner of the method embodiment can be applied to the terminal embodiment, and a same technical effect can be achieved. Specifically, FIG. 10 is a schematic diagram of a hardware structure of a terminal according to an embodiment of this application.

The terminal 1000 includes but is not limited to at least a part of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

It may be understood by a person skilled in the art that the terminal 1000 may further include a power supply (such as a battery) that supplies power to each component. The power supply may be logically connected to the processor 1010 by using a power management system, to implement functions such as charging, discharging, and power consumption management by using the power management system. The terminal structure shown in FIG. 10 constitutes no limitation on the terminal, and the terminal may include more or fewer components than those shown in the figure, or combine some components, or have different component arrangements. Details are not described herein.

It should be understood that in this embodiment of this application, the input unit 1004 may include a graphics processing unit (Graphics Processing Unit, GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1001 may transmit the downlink data to the processor 1010 for processing. In addition, the radio frequency unit 1001 may send uplink data to the network side device. Generally, the radio frequency unit 1001 includes but is not limited to an antenna, an amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may include a volatile memory or a non-volatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1009 in this embodiment of this application includes but is not limited to these memories and any memory of another proper type.

The processor 1010 may include one or more processing units. Optionally, an application processor and a modem processor are integrated into the processor 1010. The application processor mainly processes an operating system, a user interface, an application, or the like. The modem processor mainly processes a wireless communication signal, for example, a baseband processor. It may be understood that, alternatively, the modem processor may not be integrated into the processor 1010.

The processor 1010 is configured to determine CSI corresponding to N second ports based on channel state information reference signals CSI-RSs corresponding to M first ports. The radio frequency unit 1001 is configured to: send the CSI corresponding to the N second ports to a network side device; and determine the CSI corresponding to the N second ports based on the CSI-RSs corresponding to the M first ports; where the N second ports are CSI-RS ports configured by the network side device for the terminal, and the M first ports are some ports in the N second ports.

Optionally, the first port is mapped in a same polarization direction to M1 ports in a horizontal dimension and M2 ports in a vertical dimension, the second port is mapped in a same polarization direction to N1 ports in the horizontal dimension and N2 ports in the vertical dimension, M1 is less than or equal to N1, or M2 is less than or equal to N2, M1, M2, N1, and N2 each are an integer greater than 0, M=M1*M2*2, and N=N1*N2*2.

Optionally, the radio frequency unit 1001 is further configured to receive first indication information sent by the network side device. The first indication information includes at least one of the following: a pattern of a CSI-RS resource, where the pattern of the CSI-RS resource includes M1 first ports in the horizontal dimension, M2 first ports in the vertical dimension, N1 second ports in the horizontal dimension, and N2 second ports in the vertical dimension; and a first mapping relationship, where a mapping relationship between the N1 second ports and the M1 first ports or a mapping relationship between the N2 second ports and the M2 first ports is configured in the first mapping relationship.

Optionally, the first mapping relationship is indicated by at least one of the following: a bitmap; and second indication information used to indicate that one of a plurality of mapping relationships that are preconfigured or that are agreed upon in a protocol is the first mapping relationship.

Optionally, the bitmap includes at least one of the following: a first bitmap, where a length of the first bitmap is N1, and the first bitmap is used to indicate a mapping relationship between the second port and the first port in the horizontal dimension; a second bitmap, where a length of the second bitmap is N2, and the second bitmap is used to indicate a mapping relationship between the second port and the first port in the vertical dimension; a third bitmap, where a length of the third bitmap is N1*N2, and the third bitmap is used to indicate a mapping relationship between a second port and a first port in each polarized antenna group in a dual-polarized antenna group, or the third bitmap is used to indicate a mapping relationship between a second port and a first port in a specific polarized antenna group in a dual-polarized antenna group; and a fourth bitmap, where a length of the fourth bitmap is N1*N2*2, and the fourth bitmap is used to indicate a mapping relationship between a second port and a first port in a dual-polarized antenna group.

Optionally, the processor 1010 is further configured to: when the CSI-RS is received at a specific moment in the CSI-RS resource, determine that the first mapping relationship takes effect or is activated.

Optionally, the first mapping relationship is related to first capability information of the terminal, where the first capability information is used to indicate that the terminal supports a second quantity of first ports when the terminal is configured with and a mapping relationship or a ratio relationship between the second quantity of first ports and the first quantity of second ports.

Optionally, that the processor 1010 determines the CSI corresponding to the N second ports based on the CSI-RSs corresponding to the M first ports includes: estimating the CSI corresponding to the N second ports based on the CSI-RSs corresponding to the M first ports and a spatial-domain filtering coefficient.

Optionally, the spatial-domain filtering coefficient is obtained in at least one of the following manners: being obtained based on a first downlink RS through measurement, where the first downlink RS is the CSI-RS; being obtained based on a second downlink RS through measurement, where the second RS is a multi-port RS, and the second downlink RS is different from the CSI-RS; being obtained based on a third downlink RS through measurement, where the third downlink RS is a precoding RS subjected to beamforming or delay compensation; and receiving a spatial-domain filtering coefficient sent by the network side device.

Optionally, a port pattern corresponding to the second downlink RS is a subset or a full set of a pattern of the second port.

Optionally, when the terminal obtains the spatial-domain filtering coefficient through measurement based on the second downlink RS or the third downlink RS, a TCI state quasi co-location reference signal corresponding to the CSI-RS includes the second downlink RS or the third downlink RS, or the CSI-RS has a same TCI state quasi co-location reference signal as the second downlink RS or the third downlink RS.

Optionally, when the spatial-domain filtering coefficient is sent by the network side device, the spatial-domain filtering coefficient is indicated or represented by at least one of the following: a K1×1 vector, used to represent a correlation between inter-index differences of K1 second antenna ports in the horizontal dimension, where K1 is less than N1; a K2×1 vector, used to represent a correlation between inter-index differences of K2 second antenna ports in the vertical dimension, where K2 is less than N2; a K1×K2 two-dimensional correlation matrix, used to represent an autocorrelation matrix of inter-index differences between K1 second antenna ports in the horizontal dimension and K2 second antenna ports in the vertical dimension, where K1 is less than N1, and K2 is less than N2; a beam index; a discrete Fourier transform DFT basis index; a relative power difference corresponding to different beam indexes; and a relative power difference corresponding to different DFT basis indexes.

Optionally, the radio frequency unit 1001 is configured to send second capability information to the network side device, where the second capability information is used to indicate at least one of the following: a maximum quantity of ports, where the maximum quantity of ports is obtained by counting first ports or second ports in all activated CSI-RS resources that are processed by the terminal in any time domain unit and associated with a CSI report; a quantity of first ports in all activated CSI-RS resources that are processed by the terminal in any time domain unit and associated with a CSI report; and a quantity of second ports in all activated CSI-RS resources that are processed by the terminal in any time domain unit and associated with a CSI report.

Optionally, at least one of the following is satisfied: a quantity of CSI processing units associated with the CSI report is related to first information, and the first information is a ratio of the quantity of second ports to the quantity of first ports; the quantity of CSI processing units associated with the CSI report is determined based on a quantity of first CSI processing units and a predetermined value, and the first CSI processing unit is a CSI unit used when the terminal determines the CSI corresponding to the N second ports based on CSI-RSs corresponding to the N second ports; and a target parameter configured in a CSI-RS resource associated with the CSI report is associated with the second port, where the target parameter includes a power control offset.

It may be understood that, for an implementation process of the implementations mentioned in this embodiment, reference may be made to related descriptions of the method embodiments 200 to 400, and a same or corresponding technical effect is achieved. To avoid repetition, details are not described herein again.

An embodiment of this application further provides a network side device, including a processor and a communication interface. The communication interface is coupled to the processor, and the processor is configured to run a program or instructions, to implement the steps in the method embodiment shown in FIG. 6. This embodiment of the network side device corresponds to the foregoing method embodiment of the network side device. Each implementation process and implementation of the foregoing method embodiment may be applicable to this embodiment of the network side device, and a same technical effect can be achieved.

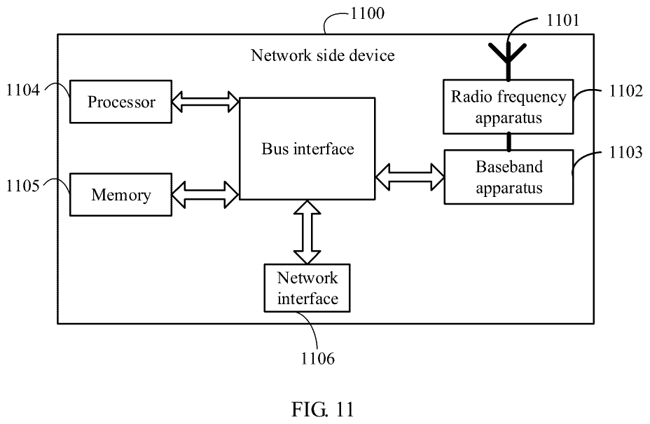

Specifically, an embodiment of this application further provides a network side device. As shown in FIG. 11, the network side device 1100 includes an antenna 1101, a radio frequency apparatus 1102, a baseband apparatus 1103, a processor 1104, and a memory 1105. The antenna 1101 is connected to the radio frequency apparatus 1102. In an uplink direction, the radio frequency apparatus 1102 receives information through the antenna 1101, and sends the received information to the baseband apparatus 1103 for processing. In a downlink direction, the baseband apparatus 1103 processes information that needs to be sent, and sends processed information to the radio frequency apparatus 1102. The radio frequency apparatus 1102 processes the received information, and sends processed information through the antenna 1101.

In the foregoing embodiment, the method performed by the network side device may be implemented in the baseband apparatus 1103. The baseband apparatus 1103 includes a baseband processor.

For example, the baseband apparatus 1103 may include at least one baseband board. A plurality of chips are disposed on the baseband board. As shown in FIG. 11, one chip is, for example, a baseband processor, and is connected to the memory 1105 by using a bus interface, to invoke a program in the memory 1105 to perform the operations of the network device shown in the foregoing method embodiment.

The network side device may further include a network interface 1106, and the interface is, for example, a common public radio interface (Common Public Radio Interface, CPRI).

Specifically, the network side device 1100 in this embodiment of this application further includes an instruction or a program that is stored in the memory 1105 and that can run on the processor 1104. The processor 1104 invokes the instruction or the program in the memory 1105 to perform the method performed by the modules shown in FIG. 8, and a same technical effect is achieved. To avoid repetition, details are not described herein again.

An embodiment of this application further provides a readable storage medium. The readable storage medium stores a program or instructions. When the program or the instructions are executed by a processor, the processes of the foregoing embodiment of the channel state information determining method can be implemented, and a same technical effect can be achieved. To avoid repetition, details are not described herein.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or instructions to implement the processes of the foregoing embodiment of the channel state information determining method, and a same technical effect can be achieved. To avoid repetition, details are not described herein again.

The processor mentioned in this application may include a general purpose processor, a dedicated processor, and the like. For example, the processor includes a central processing unit (Central Processing Unit, CPU), a microprocessor, a digital signal processor (Digital Signal Processor, DSP), an artificial intelligent (Artificial Intelligent, AI) processor, a graphics processing unit (Graphics Processing Unit, GPU), an application specific integrated circuit (Application Specific Integrated Circuit, ASIC), a network processor (Network Processor, NP), a field programmable gate array (Field Programmable Gate Array, FPGA), or another programmable logic device, a gate circuit, a transistor, or a discrete hardware component.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the foregoing embodiment of the channel state information determining method, and a same technical effect can be achieved. To avoid repetition, details are not described herein again.

An embodiment of this application further provides a wireless communication system, including a terminal and a network side device. The terminal may be configured to implement the processes of the foregoing embodiments 200 to 400 of the channel state information determining method. The network side device may be configured to implement the processes of the foregoing embodiment 600 of the channel state information determining method. A same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product in addition to a necessary universal hardware platform or certainly by hardware. The computer software product is stored in a storage medium (such as a ROM, a RAM, a magnetic disk, or an optical disc), and includes several instructions for instructing a terminal or a network side device to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms of implementations without departing from the purpose of this application and the protection scope of the claims, all of which fall within the protection of this application.

1. A channel state information (CSI) determining method, comprising:
determining, by a terminal, CSI corresponding to N second ports based on channel state information reference signals (CSI-RSs) corresponding to M first ports, where M and N each are an integer greater than 1; and
sending the CSI corresponding to the N second ports to a network side device; wherein
the N second ports are CSI-RS ports configured by the network side device for the terminal, and the M first ports are some ports in the N second ports.

2. The method according to claim 1, wherein the first port is mapped in a same polarization direction to M1 ports in a horizontal dimension and M2 ports in a vertical dimension, the second port is mapped in a same polarization direction to N1 ports in the horizontal dimension and N2 ports in the vertical dimension, M1 is less than or equal to N1, or M2 is less than or equal to N2, M1, M2, N1, and N2 each are an integer greater than 0, M=M1*M2*2, and N=N1*N2*2.

3. The method according to claim 2, wherein the method further comprises:
receiving first indication information sent by the network side device, wherein
the first indication information comprises at least one of the following:
a pattern of a CSI-RS resource, wherein the pattern of the CSI-RS resource comprises M1 first ports in the horizontal dimension, M2 first ports in the vertical dimension, N1 second ports in the horizontal dimension, and N2 second ports in the vertical dimension; and
a first mapping relationship, wherein a mapping relationship between the N1 second ports and the M1 first ports or a mapping relationship between the N2 second ports and the M2 first ports is configured in the first mapping relationship.

4. The method according to claim 3, wherein the first mapping relationship is indicated by at least one of the following:
a bitmap; and
second indication information used to indicate that one of a plurality of mapping relationships that are preconfigured or that are agreed upon in a protocol is the first mapping relationship.

5. The method according to claim 4, wherein the bitmap comprises at least one of the following:
a first bitmap, wherein a length of the first bitmap is N1, and the first bitmap is used to indicate a mapping relationship between the second port and the first port in the horizontal dimension;
a second bitmap, wherein a length of the second bitmap is N2, and the second bitmap is used to indicate a mapping relationship between the second port and the first port in the vertical dimension;
a third bitmap, wherein a length of the third bitmap is N1*N2, and the third bitmap is used to indicate a mapping relationship between a second port and a first port in each polarized antenna group in a dual-polarized antenna group, or the third bitmap is used to indicate a mapping relationship between a second port and a first port in a specific polarized antenna group in a dual-polarized antenna group; and
a fourth bitmap, wherein a length of the fourth bitmap is N1*N2*2, and the fourth bitmap is used to indicate a mapping relationship between a second port and a first port in a dual-polarized antenna group.

6. The method according to claim 4, wherein the method further comprises:
when the CSI-RS is received at a specific moment in the CSI-RS resource, determining that the first mapping relationship takes effect or is activated.

7. The method according to claim 4, wherein the first mapping relationship is related to first capability information of the terminal; and
the first capability information is used to indicate that the terminal supports a second quantity of first ports when the terminal is configured with a first quantity of second ports and a mapping relationship or a ratio relationship between the second quantity of first ports and the first quantity of second ports.

8. The method according to claim 1, wherein the determining, by a terminal, CSI corresponding to N second ports based on CSI-RSs corresponding to M first ports comprises:
estimating the CSI corresponding to the N second ports based on the CSI-RSs corresponding to the M first ports and a spatial-domain filtering coefficient.

9. The method according to claim 8, wherein the spatial-domain filtering coefficient is obtained by using at least one of the following:
obtained by the terminal through measurement based on a first downlink RS, wherein the first downlink RS is the CSI-RS;
obtained by the terminal through measurement based on a second downlink RS, wherein the second downlink RS is a multi-port RS, and the second downlink RS is different from the CSI-RS;
obtained by the terminal through measurement based on a third downlink RS, wherein the third downlink RS is a precoding RS subjected to beamforming or delay compensation; and
receiving, by the terminal, a spatial-domain filtering coefficient sent by the network side device.

10. The method according to claim 9, wherein a port pattern corresponding to the second downlink RS is a subset or a full set of a pattern of the second port.

11. The method according to claim 9, wherein when the terminal obtains the spatial-domain filtering coefficient through measurement based on the second downlink RS or the third downlink RS, a transmission configuration indicator state (TCI) state quasi co-location reference signal corresponding to the CSI-RS comprises the second downlink RS or the third downlink RS, or the CSI-RS has a same TCI state quasi co-location reference signal as the second downlink RS or the third downlink RS.

12. The method according to claim 9, wherein when the spatial-domain filtering coefficient is sent by the network side device, the spatial-domain filtering coefficient is indicated or represented by at least one of the following:
a K1×1 vector, used to represent a correlation between inter-index differences of K1 second antenna ports in the horizontal dimension, wherein K1 is less than N1;
a K2×1 vector, used to represent a correlation between inter-index differences of K2 second antenna ports in the vertical dimension, wherein K2 is less than N2;
a K1×K2 two-dimensional correlation matrix, used to represent an autocorrelation matrix of inter-index differences between K1 second antenna ports in the horizontal dimension and K2 second antenna ports in the vertical dimension, wherein K1 is less than N1, and K2 is less than N2;
a beam index;
a discrete Fourier transform (DFT) basis index;
a relative power difference corresponding to different beam indexes; and
a relative power difference corresponding to different DFT basis indexes.

13. The method according to claim 1, wherein the method further comprises:
sending second capability information to the network side device, wherein
the second capability information is used to indicate at least one of the following:
a maximum quantity of ports, wherein the maximum quantity of ports is obtained by counting first ports or second ports in all activated CSI-RS resources that are processed by the terminal in any time domain unit and associated with a CSI report;
a quantity of first ports in all activated CSI-RS resources that are processed by the terminal in any time domain unit and associated with a CSI report; and
a quantity of second ports in all activated CSI-RS resources that are processed by the terminal in any time domain unit and associated with a CSI report.

14. The method according to claim 1, wherein at least one of the following is satisfied:
a quantity of CSI processing units associated with the CSI report is related to first information, and the first information is a ratio of the quantity of second ports to the quantity of first ports;
the quantity of CSI processing units associated with the CSI report is determined based on a quantity of first CSI processing units and a predetermined value, and the first CSI processing unit is a CSI unit used when the terminal determines the CSI corresponding to the N second ports based on CSI-RSs corresponding to the N second ports; and
a target parameter configured in a CSI-RS resource associated with the CSI report is associated with the second port, wherein the target parameter comprises a power control offset.

15. A channel state information (CSI) determining method, comprising:
receiving, by a network side device, channel state information (CSI) corresponding to N second ports that is sent by a terminal, wherein
the CSI corresponding to the N second ports is determined based on channel state information reference signals (CSI-RSs) corresponding to M first ports, the N second ports are CSI-RS ports configured by the network side device for the terminal, and the M first ports are some ports in the N second ports, where M and N each are an integer greater than 1.

16. The method according to claim 15, wherein the method further comprises:
sending first indication information to the terminal, wherein
the first indication information comprises at least one of the following:
a pattern of a CSI-RS resource, wherein the pattern of the CSI-RS resource comprises M1 first ports in the horizontal dimension, M2 first ports in the vertical dimension, N1 second ports in the horizontal dimension, and N2 second ports in the vertical dimension; and
a first mapping relationship, wherein a mapping relationship between the N1 second ports and the M1 first ports or a mapping relationship between the N2 second ports and the M2 first ports is configured in the first mapping relationship.

17. The method according to claim 15, wherein the method further comprises at least one of the following:
sending a first downlink reference signal (RS) to the terminal, wherein the first downlink RS is the CSI-RS;
sending a second downlink RS to the terminal, wherein the second downlink RS is a multi-port RS, and the second downlink RS is different from the CSI-RS;
sending a third downlink RS to the terminal, wherein the third downlink RS is a precoding RS subjected to beamforming or delay compensation; and
sending a spatial-domain filtering coefficient to the terminal, wherein the spatial-domain filtering coefficient is obtained based on uplink channel measurement; wherein
the first downlink RS, the second downlink RS, or the third downlink RS is used by the terminal to determine the spatial-domain filtering coefficient.

18. The method according to claim 15, wherein the method further comprises:
receiving second capability information sent by the terminal, wherein
the second capability information is used to indicate at least one of the following:
a maximum quantity of ports, wherein the maximum quantity of ports is obtained by counting first ports or second ports in all activated CSI-RS resources that are processed by the terminal in any time domain unit and associated with a CSI report;
a quantity of first ports in all activated CSI-RS resources that are processed by the terminal in any time domain unit and associated with a CSI report; and
a quantity of second ports in all activated CSI-RS resources that are processed by the terminal in any time domain unit and associated with a CSI report.

19. A terminal, comprising a processor and a memory, wherein the memory stores a program or instructions capable of running on the processor, and when the program or the instructions, when executed by the processor, implementing a channel state information determining method, comprising:
determining CSI corresponding to N second ports based on channel state information reference signals (CSI-RSs) corresponding to M first ports, where M and N each are an integer greater than 1; and
sending the CSI corresponding to the N second ports to a network side device; wherein the N second ports are CSI-RS ports configured by the network side device for the terminal, and the M first ports are some ports in the N second ports.

20. A network side device, comprising a processor and a memory, wherein the memory stores a program or instructions capable of running on the processor, and when the program or the instructions are executed by the processor, the steps of the method according to claim 15 are implemented.
